(19) United States
(12) Patent Application Publication
(10) Pub. No.: US 2015/0257417 A1
(43) Pub. Date: Sep. 17, 2015

(54) FOOD PRODUCT MADE FROM PLANT PARTS CONTAINING STARCH AND METHOD FOR THE PRODUCTION OF SAID FOOD PRODUCT

(71) Applicant: EMSLAND-STÄRKE GMBH, Emlichheim (DE)

(72) Inventors: Karl Ludwig Woll, Ahaus (DE); Mareen Vette, Hoogstede (DE)

(73) Assignee: Emsland-Stärke GmbH, Emlichheim (DE)

(21) Appl. No.: 14/439,755

(22) PCT Filed: Oct. 15, 2013
(86) PCT No.: PCT/IB2013/059358

§ 371 Date: Apr. 30, 2015

(30) Foreign Application Priority Data
Nov. 2, 2012 (DE) 20 2012 104 218.5

(51) Int. Cl. A23L 1/0522; A23L 1/0528

(52) U.S. Cl. CPC A23L 1/0522; A23L 1/0528; A23V 2002/00

(57) ABSTRACT

A vegetable particulate food product produced from plant parts containing starch and having at least one constituent that can be removed by means of water that is reduced by 20 to 90 wt % of the original content in comparison with the native plant part, and a method for producing such a food product.

### CROSS REFERENCE TO RELATED CASES

This application is the U.S. National Phase of PCT Application PCT/IB2013/059358 and the non-provisional conversion of U.S. Provisional Application 61/732,614.

### BACKGROUND OF THE INVENTION

1. Field of the Invention

The invention relates to a dried plant-based food product made from plant parts containing starch, as well as to the process for the production of said food product.

2. Description of Related Art

Plant-based food products made of plant parts containing starch are commonly used and commercially available in various forms. They are used in traditional local cuisines or in animal feed, e.g., soy flours, soy flakes, cereal flakes, potato flakes, chickpea flour, rice flour, beet pulp, banana chips or dried bananas, tapioca flour, and many more. What all these products have in common is that their purpose is to provide low-moisture or also storable forms of food. In some foods, such as, e.g., in tapioca, thermal treatment for deactivating unfavorable components is indispensable. Flakes made of other starch-containing plant parts are also known. Thus, i.e., in the U.S. and in Europe potato flakes have been in use for a long time for making mashed potatoes and the like (see, German Patent Application DE 2428546 and corresponding U.S. Pat. No. 4,156,032 or German Patent Application DE 1119641 B). European Patent Application EP 0144755 B also deals with the production of potato flakes.

Similarly well-known are cereal flakes, such as oat flakes. So, already in 1895, GB D189522087 deals with the manufacture of cereal flakes by means of roller drying. Depending on the cultural region there are also soy flakes, banana flakes, apple flakes etc.

From German Patent DE 1119641 B, a method for manufacturing a dried product made of dried mashed potatoes in the form of comminuted flakes has become known, wherein peeled, mashed and cooked potatoes are dried into a film by using one or multiple heated rollers. Similar methods are known from the Austrian Patent Application AT 5125 as well as from: Parow, Handbuch der Kartoffeltrocknerei [“Manual of Potato Drying”], 1907, p. 84-85. These potato flakes can then be further used as a preserved potato product. Through dehydration and thermal drying they are rendered much more long-life than potatoes themselves.

In the state of the art, the classic way to produce potato flakes or granulate is by drying cooked and/or raw mashed tubers, wherein they are supposed to be as close as possible to the characteristics of fresh potatoes.

Contrary to the starch process, when it comes to these so-called potato dehydrates, the constituents of the tuber (such as starch, sugar or proteins) are separated either only to a limited extent or not at all, so that the typical taste, the potato flavor as well as the puree-like texture is largely preserved.

As far as potatoes are concerned, the potato flakes traditionally made in this manner from unpeeled (or peeled) potatoes, for example, show a very rapid and considerable swelling even in cold water due to their colloidochemical properties, with this swelling being characteristic. During the production process, the potato cells burst, releasing free starch, proteins, fibers, alkaloids etc. into the intercellular spaces. This results in a deliquescent and non-shapable mass. In cooked and conditioned potatoes, the intact cells surround the agglutinated starch substrate (amylopectin and amylose), preventing the release of starch substance into the intercellular spaces and hence the formation of a paste despite strong moisture expansion. Therefore, flakes made of cooked and conditioned potatoes can be readily shaped and do not have a mucous, deliquescent texture. The production of potato flakes is now carried out with a predetermined layer thickness of the soft potato mash that is placed on/between heated drying rollers.

Apart from the colloidochemical properties, what is shown by microscopic images of conventional cooked potato flakes and of uncooked potato flakes is that in the cooked flakes the burst cells are clearly perceivable, while in the uncooked puree flakes the starch is located inside the cell. The intact cells that can be dyed with iodine lie clearly separated from each other, with barely any starch substance being released into the intercellular spaces (DE 1119641B).

Other methods of producing potato flakes and granulates are also described extensively, e.g., in “Potato Processing”, 4th Edition, Editor: W. S. Talburt and O. Smith, AVI, USA, 1987. In order to avoid repetitions, this literature is explicitly referred to as knowledge of the person skilled in the art.

Generally, the flake production process is suitable for all plant parts containing starch, particularly also for plants which have an increased content of particular forms of starch, such as amylopectin. Such plants are known and available as “waxy plants” or “amylopectin plants”, as for example the potato Amflora®. Thus, in International Patent Application Publication WO 2004/005516 A1 which corresponds to U.S. Patent Application Publication 2006/0174366, International Patent Application Publication WO 97/20040 A1 which corresponds to U.S. Pat. No. 6,469,231 and International Patent Application Publication WO 92/11376A1 which corresponds to U.S. Pat. Nos. 5,824,798 and 6,784,338 genetically modified potatoes are described that contain different types of amylopectin or differing ratios of amylopectin to amylose as compared to unmodified potatoes.

It is also known, as is, e.g., explained in European Patent Application EP 0565386 B1, that high amylopectin content is desirable in crispy baked foods (potato chips, crispbread, biscuits). This is confirmed in the more recent summarizing publications by J. A. De Vries, “NIEUWE MOGELIJKHEDEN MET AMYLOPECTINE-AARDAPPELZETMEEL” VOEDINGSMIDDLEN TECHNOLOGIE, NL, NOORDERVLIET B.V. ZEIST, Vol. 28, No 23, Nov. 1, 1995, p. 26, 27 (ISSN:0042-7934). As has been explained in British Patent Application GB 1306384 A as early as Feb. 7, 1973, the (1) moistening of a composition with an amylopectin product comprising less than 5 wt. % of amylose; (2) heating up the moist mass under the application of pressure inside a mixing device for the purpose of gelatinizing and hydrating the amylopectin product; (3) forming this composition and subjecting this formed dough to thermal treatment yields a food product of particular crispiness and light texture. Since amylopectin with its branched chains binds water well, this leads to the desired crispiness in baking and frying steps.

In view of today's requirements, these known flake products containing starch are capable of being improved. However, at the same time, undesired plant constituents remain in the final dried product in the course of dry product hydrate production as the potato cells are supposed to stay intact as far as possible in the flake and granulate production; hence no effective elution of the mostly intracellularly bound components is possible.

When it comes to potatoes and other starch plants such as grain, legume fruits and other tubers, what is considered to be undesirable are sugars, glycoalkaloids and certain proteins or amino acids, such as asparagine, which lead to a Maillard reaction resulting in carcinogenic products during browning.

In the production processes for flakes or granulate as they have been established so far, there is no available procedural possibility for fruit water separation, which, however, leads to these disadvantageous components remaining in the dry product.

In order to avoid acrylamides in the heated-up foods, an optimization of the food production can be undertaken. There are several approaches to counteract the formation of acrylamides in heated-up foods. Apart from the optimization of the processes of food production, for example through lower processing temperatures and frying times that are as short as possible, additives may also be admixed to the food or to one of its components for the purpose of breaking down or blocking acrylamide precursors. Another option is using special plant varieties with low contents of acrylamide-forming precursors.

As far as potato products go, according to the current state of the art special potato breeds with low reducing sugar contents and high storage stability can be used for minimizing acrylamide in potato flakes. As other measure, harvest times can be optimized (unripe potatoes have a higher content of reducing sugars) and advantageous storage conditions at temperatures of no less than 6° C. can be created. In contrast, in potatoes the content of the amino acid asparagine, which is important for the plant growth hormone, cannot yet be controlled.

### SUMMARY OF THE INVENTION

Therefore, it is an object of the invention to create better plant-based flakes out of plant parts containing starch.

This problem is solved by the plant-based food product and methods for producing the same as described herein.

The flakes according to the invention are preserved, dietetically valuable, but also safer to handle in baking and frying applications as they are applied in traditional forms of processing. Moreover, storability is increased due to the depletion of easily perishable or easily digestible substances, such as soluble sugars, free starch or protein. Since it has been found that the co-presence of protein and sugar in a food (e.g., in flour products) can lead to a Maillard reaction during the heating process, in the course of which a carcinogenic acrylamide can be produced, it is desirable to avoid or at least reduce the co-presence of these two substance groups in foods which are heated up. This is achieved according to the invention.

Thus, according to the invention food products made out of plant parts containing starch with enhanced storability and less proneness to the Maillard reaction can be produced. In addition, they have a higher share in health-promoting fibers compared to non-depleted products, so that they can be a valuable contribution to diets.

Through a controlled depleting of the comminuted plant parts of their starch, protein and soluble sugars in the elution process, the content of reducing sugars and thus the glycaemic degradation of the flake products is decelerated, among other things. Also reduced are proteins and amino acids which may possibly lead to allergies or to a Maillard reaction and to the formation of the carcinogenic substance acrylamide. In this way, the tendency to the formation of such harmful substances during the food preparation process can be reduced and the requirements of the food laws can be met. Since the proteins (also those that are allergenic) are washed-out, the foods can be produced in a form that is more compatible for people with allergies. On the other hand, the content of fibers and products that can be digested only slowly or not at all and that is considered to be health-promoting is increased. Nevertheless, the comminuted plant parts substantially retain the original shape and also the taste of the original plant part; only the rapidly dissolvable and hence rapidly absorbable carbohydrates with a high glycaemic index and proteins are washed-out, so that a food product with a low glycaemic index is arrived at.

Compared to conventional products made of comminuted plant parts—such as conventional oat flakes or potato flakes—the product according to the invention has a reduced total starch content and/or total protein content, while still retaining the flake-like functionality (texture, crunch, and hydrophilicity).

A comparison of the production process for the new plant products to the conventional production methods for products made of comminuted plant parts, such as cereal flakes or potato flakes, shows that a considerably more energy-saving and eco-friendly production method is achieved while also yielding a nutritionally enhanced product, which is due to the fact that the temperature treatment is preferably applied exclusively to the depleted intermediate product.

This means that compared to the former ways of processing into dry products, a simplification of the process as compared to the thermal treatment of intact plant parts becomes possible while at the same time production costs are reduced and an additional starch and protein isolation is facilitated.

In the following, the invention is described in more detail by referring to the accompanying drawings as well as to exemplary embodiments, to which, however, it is not limited.

### BRIEF DESCRIPTION OF THE DRAWINGS

FIG. 1 schematically shows a production process for the food product according to the invention; and

FIG. 2 shows photos of chips made with the flakes according to the invention as compared to conventional chips.

### DETAILED DESCRIPTION OF THE INVENTION

The plant product according to the invention is characterized by the following properties, among other things:

The product is swellable due to the water-absorbing starch and cellulose (fiber) content per particle.

It has a reduced content of starch and sugar (“low-calorie”) and/or protein, but a functionality that is comparable to known products.

Typical plant parts that are suitable for this process could be, for example:

root crops and tubers, such as: beets, potato, cassava; chicory, dandelion, tapioca, yams, topinambur, manioc;

legumes and their fruits, such as: peanuts, cashews, lentils, peas, wrinkled peas, beans, soy, lupines,

fruits of trees, such as: acorns, sweet chestnuts, nuts such as acorns, sweet chestnuts, nuts, dates;

herbaceous plants and fruits of herbaceous plants, such as: bananas, mango;

sweet grasses, particularly starchy pulp and fruits/seeds of the same, such as: sugarcane, wheat, rye, barley, oat, millet, corn and rice, bamboo; algae.

These plant parts and fruits have starch as well as a structure, and so far they have mostly been used only in a very partial manner (e.g., in the case of beets and sugarcane), mainly for sugar extraction. After the isolation of one substance (sugar, starch, protein), the remaining plant-based matter has mostly been suitable merely to be used as animal feed with a short shelf-life. Due to the fact that many of the substances that promote the biological degradation are washed-out according to the invention, the remaining food product keeps longer and can be utilized more efficiently.

The byproducts that are yielded here, among others, are versatile starch that can be used in many technical and non-technical applications, sugars that are suitable for use as animal feed or for human consumption, and fibers that are removable by means of water and that can be used as binders or structure forming agents.

In order to make for better processability, e.g., to reduce dust formation or to simplify food production, it may be useful to add commonly applied processing auxiliary agents selected from the group comprising: binders, emulsifiers, antioxidants, lubricants, flavoring agents, enzymes, and dyes.

Typical emulsifiers are those approved by food regulations, such as alginates; agar-agar, carrageenan, furcellaran, carob bean gum, guar gum, gum tragacanth, gum arabic, xanthan gum, sorbitol/sorbitol syrup, karaya gum, tara gum, gellan gum, mannitol, glycerin and its esters, stearates and other salts and esters of fatty acids.

Suitable antioxidants, or such that are approved by food regulations, are tocopherols, ascorbates or ascorbic acid, and sulfites etc.

Typical forms of plant-based food products are flakes (cereal flakes), “corn flakes”, oat flakes etc.), powder, and granulates.

A production method for the plant-based products according to the invention comprises the following steps: process for the production of a food product according to one of the preceding claims, with the steps:

providing plant parts containing starch,

comminuting the plant parts into particles with an average particle size (statistical mean) of 0.02 to 10 mm, preferably of 0.05 to 5 mm, and particularly preferably of 0.2 to 4 mm, adding water with a pH value of between 5.0 and 12.0, preferably a pH value of between 6.5 to 8.5, which results in an aqueous suspension containing between 10 and 50 wt. %, preferably 15 to 40 wt. %, and particularly preferred 16 to 35 wt. % of dry substance;

separating the fluid, which results in food-components;

at least one washing of the obtained food components in water until a depletion of components removable by means of water is achieved that results in 20 to 90 wt. % less in components removable by means of water; and

drying of the thus produced depleted food product particles.

In the following, the invention will be explained substantially for potatoes, but the steps can equally be used for other plant parts containing starch, such as peas, beets, sweet grasses (e.g., sugarcane), mango, dates, figs, and bananas.

In potatoes, which are referred to here as representative of other plant products containing starch, the process steps can be carried out as follows:

After washing the potatoes (“Washing”) in order to remove lose or adhering parts of the peel or foreign components such as dirt, sand, plant parts etc., it may be advantageous to peel the potatoes (“Peeling”) in order to remove constituent substances that are mostly concentrated in the outer layer of the field crop, or in order to enhance the optic quality of the final product by separation of the dark parts of the peel.

Depending on the peeling processes (“Peel processing”), the separated, high-fiber peel may be supplied for the separate use as animal feed or for extraction of potato fibers and/or starch. Mechanical, abrasive processes such as roller or drum peeling and blade peeling processes represent suitable peeling processes for potatoes as well as for tubers in general. Steam peeling is also possible. Different peeling processes can also be combined or carried out in succession.

Before peeling it may be advantageous to let certain plant products swell in water, possibly after the pH adjustment by means of acids or bases. After the peel has been separated, the potatoes are comminuted (“Disintegration’), which can be achieved by utilizing grading or grinding technology, such as e.g., ultra graders, sawmills, hammer mills or also by means of high-pressure homogenizers. The kind of comminuting process that is used depends, among other things, on the consistency of the solids content of the plant raw material as well as on the desired degree of cell disruption. It may also be advantageous to add antioxidants or other auxiliary agents, e.g., for control of germ contamination, during or shortly after the fruit is comminuted.

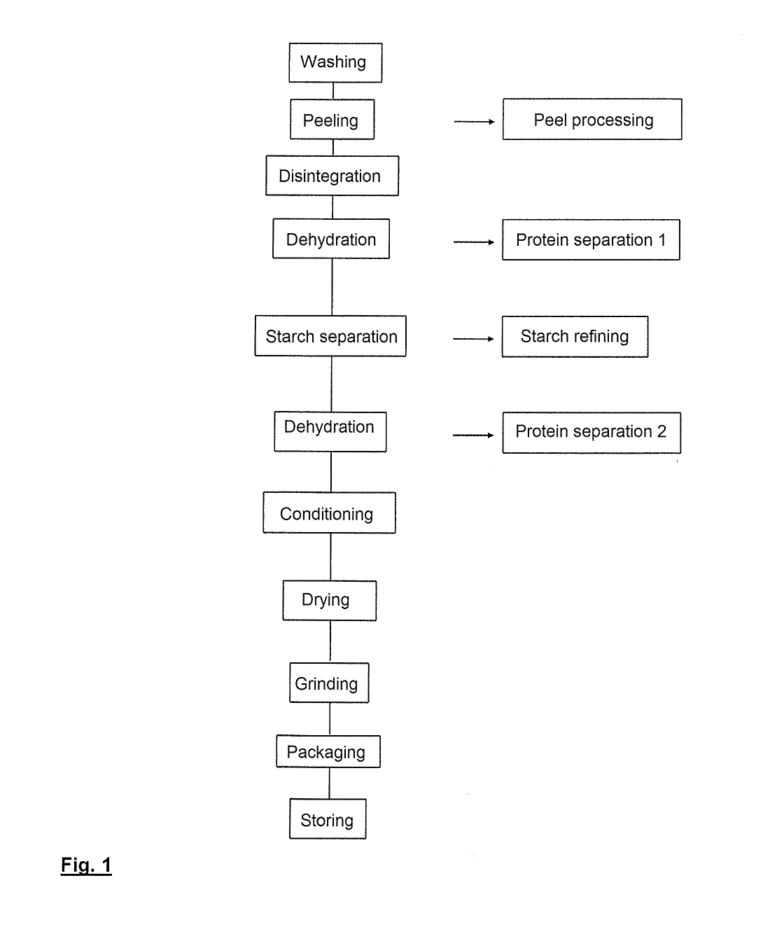

A typical course of the process is shown in FIG. 1:

The plant part is mostly cleaned and peeled and, where necessary, blanched or cooked. Before the elution steps are carried out, the food is usually comminuted by a grader, a cutting unit, grinder, striking mechanism, or the like, as is known to a person skilled in the art.

After the disintegration has been completed—here explained by reference to potatoes—the fruit water is drained from the resulting grated plant parts for further protein separation and processing (“Protein separation 1”). Here, the fruit water separation is usually carried out by means of centrifugation technology (“Dehydration 1”). After dilution of the grated plant parts, which has previously been dehydrated, with fresh water, the starch and the still remaining undesired fruit water components can be separated (“Starch separation”). The starch is separated, for example by using per se known eluents, and subsequently processed further (“Starch refining”).

The dilution with water of the grated plant parts depleted in starch and a subsequent dehydration by means of centrifugation technology comprise the second washing step (“Dehydration 2”). Here, undesired fruit water components that are still present are separated one more time and the solids content of the grated plant parts is increased in preparation of drying. The separated fruit water can in turn be drained for further protein separation and processing (“Protein separation 2”.)

Subsequently, the cleaned grated plant parts is dried (“Drying”). It may be advantageous to add auxiliary agents to the grated plant parts for enhancing processability, optical appearance or storability before drying and/or conditioning the grated plant parts, i.e., submitting it to a heat treatment step with or without subsequent cooling (“Conditioning”).

Drying of the grated plant mixture is carried out e.g., by means of contact drying, for example by means of heated rollers, but can also be carried out in a contactless manner by means of radiation or convection drying.

Afterwards, the dried product is adjusted by grinding and screening it until the desired grain size distribution is reached (“Grinding”), it is then bagged (“Packaging”) and stored away (“Storing”).

Thus, compared to conventional potato flakes or granulates, potato products made by utilizing this process have a far lower content of substances that are separable in the aqueous phase, such as proteins, glycoalkaloids, sugars and asparagine.

What is more, the starch or protein depletion can be flexibly adjusted, i.e., made-to-measure contents of these components can be set, and the partly separated starch or protein can be additionally marketed. At this, the typical characteristics of the potato flakes such as taste, smell and puree-like texture after swelling in water are by and large preserved.

While in German Patent Application DE60125772 and related U.S. Pat. No. 6,777,020 potato products as well as methods for their production from flakes with a share of burst potato cells of under 70% are described, in the products according to the invention, a considerably higher degree of cell disruption can additionally be set depending on the design of the crushing step (“Disintegration”).

In extruded snacks, for example, the use of these relatively highly broken down products can lead to a considerably higher volume increase during expansion as compared to conventional potato flakes due to the higher “fine” starch content.

The desintegrating process can be carried out under anti-oxidant conditions, such as a protective atmosphere, for example, through the classic addition of ascorbic acid or sulfites, or tocopherols as well as protective gas in order to avoid the plant parts from turning brown. But also anti-oxidants such as ascorbic acid can be added. If necessary, approved emulsifiers can be selected, which are traditionally customary for the respective foods, such as lecithin, whey proteins etc.

Classical applications of the plant-based food products are food starting materials, dietary foods or food supplements for human or animal consumption, and as preserved dimensionally stable animal feed. Thus, they are suitable, for example, for use as snacks, coating masses, baked goods, extrudates, and animal feed, or as microorganism nutrients.

Unless otherwise specified, all specifications in this description refer to wt. %; and the average values are always the statistical mean.

### Example 1

### Depletion of Protein, Starch and Fruit Water Components

10 kg of potatoes of the sort Festin were cleaned, peeled and graded by means of a grader into a grated plant parts with a particle size of between 0.02 and 5 mm. After setting the grated plant parts concentration to 20% of dry matter (if necessary by adding water), 100 mg/l of sodium hydrogen sulfite were added. After adding 100 mg/l of sodium hydrogen sulfite, the fruit water of this grated plant parts suspension was separated by means of a centrifuge and drained for the purpose of further protein extraction. In order to deplete the starch, the remaining grated plant parts was now treated multiple times with fresh water at temperatures between 10° C. and 30° C. inside a centrifuge screen with a slot width of 110 p.m.

The depleted grated plant parts was dehydrated once more by means of a centrifuge in order to further increase the solids content, and was subsequently put into a heatable mixing container, where it was heated up to 65° C., followed by the admixture of 0.5% of a sucroglyceride soluble at 65° C. as an emulsifier.

Now the mixture was transferred onto a roller dryer where it was dried until it had residual moisture of 6.0%.

The grated plant parts cake was now removed from the drying drum and transferred to a grinder by which the grated plant parts cake was comminuted into particles of a size of up to 2.0 mm.

The analysis of the plant product thus obtained yielded the following results as compared to grated plant parts which had not been depleted (values respectively referring to the dry matter).

| | educt | food product according |
|---|---|---|
| | (grated plant parts) | to the invention |
| starch content1) | 81.0% | 52.8% |
| protein content2) | 9.2% | 5.2% |
| sugar content (reducing)3) | 0.32% | 0.06% |
| glycoalkaloid content 4) | 120 ppm | 75 ppm |

Determinations were carried out according to the following methods:

1): Polarimetric process according to Ewers, DIN EN ISO 10520
2): Nitrogen determination according to Kjeldahl (Nx6, 25), DIN EN ISO 3188
3): Process according to Luff-Schoorl, NEN 3571

### 4): Process 997.13, Association of Analytical Communities (AOAC)

### Example 2

### Depletion of Protein, Starch and Fruit Water Components

10 kg of potatoes of the sort Festin were cleaned, peeled and graded by means of a grader into a grated plant parts with a particle size of between 0.02 and 5 mm. After setting the grated plant parts concentration to 20% of dry matter (if necessary by adding water), 100 mg/l of sodium hydrogen sulfite and 1 g of ascorbic acid were added. The grated plant parts thus treated was dehydrated by means of a centrifuge until it had a solids content of approximately 40% and the fruit water was separated for the purpose of further protein extraction.

In order to deplete the starch, the remaining grated plant parts was treated multiple times in a centrifugal sieve with fresh water at temperatures between 10° C. and 30° C. until the residual starch content determined by the polarimetric process according to Ewers was approximately 50%.

The depleted grated plant parts with a solids content of approximately 10% was dehydrated once more by means of a centrifuge until it reached a solids content of approximately 20%, and was subsequently put into a mixing container, where 1.0% of a fatty acid ester as processing agent was admixed. Now the mixture was transferred onto a roller dryer where it was dried until it had a residual moisture of 8.0%.

The grated plant parts film was now removed from the drying drum and transferred into a grinder which comminuted the plant product into particles of a size of 1.0 mm to 2.0 mm.

Analysis of the plant product thus obtained showed the following results as compared to a non-depleted grated plant mixture which had not been depleted (values respectively referring to the dry matter).

| | educt | food product according |
|---|---|---|
| | (grated plant parts) | to the invention |
| starch content1) | 81.0% | 51.4% |
| protein content2) | 9.2% | 4.9% |
| reducing sugars3) | 0.32% | 0.10% |
| glycoalkaloid content4) | 120 ppm | 71 ppm |

Determinations were carried out according to the following methods:

1): Polarimetric process according to Ewers, DIN EN ISO 10520
2): Nitrogen determination according to Kjeldahl (Nx6, 25), DIN EN ISO 3188
3): Process according to Luff-Schoorl, NEN 3571

### 4): HPLC Process 997.13, Association of Analytical Communities (AOAC)

### Example 3

### Depletion of Protein and Fruit Water Components

10,000 kg of potatoes of the sort Festin were cleaned, peeled and graded by means of a grader into a grated plant parts with a particle size of between 0.02 to 3 mm. The water content of the grated plant parts was examined and if necessary readjusted by the addition of water to approximately 22% of dry matter.

After adding approximately 200 mg/l of ascorbic acid, the grated plant parts was guided over a decanter centrifuge, where the “fruit water” was separated and supplied to further protein extraction—without separating the free starch granules from the suspended grated plant parts.

Subsequently, the grated plant parts that was depleted of protein and soluble fruit water components in a controlled manner was transferred onto a roller dryer where it was dried until it had a residual moisture of approximately 5.5%.

The grated plant parts film was removed from the drying drum, transferred into a screening machine by means of a screw conveyor and sieved over 5 mm.

Analysis of the flake-shaped plant product thus obtained showed the following results as compared to a non-depleted plant grated plant parts (values respectively referring to the dry matter).

| | educt | food product according |
|---|---|---|
| | (grated plant parts) | to the invention |
| protein content2) | 9.2% | 4.3% |
| reducing sugars3) | 0.32% | 0.20% |
| glycoalkaloid content4) | 120 ppm | 100 ppm |

Determinations were carried out according to the following methods:

1): Nitrogen determination according to Kjeldahl (Nx6, 25), DIN EN ISO 3188
2): Process according to Luff-Schoorl, NEN 3571

### 3): HPLC Process 997.13, Association of Analytical Communities (AOAC)

### Example 4

### Degree of Breakdown of a Potato Product According to the Invention after Disintegration by Means of a Cutting Mill

25 kg of potatoes of the sort Ceresta were washed, mechanically peeled and subsequently comminuted inside a cutting mill by Hosokawa with a rotational speed of the rotor between 10 and 90 m/s and a screen plate insert with a perforation having a diameter of 0.5 to 5 mm. In the potato mash thus obtained the total starch as well as the elutable (“free”) starch was determined by the polarimetric process after the washing of the grated plant parts over a screen with a mesh opening of 100 μm (9). The share of bound starch was calculated as the difference of the total starch minus the elutable starch. For the grated potato mixture thus obtained the following results were determined:

| | |
|---|---|
| total starch | 62.9% |
| elutable starch | 30.1% |
| bound starch(x) | 32.8% |
| degree of breakdown(xx) | 47.9% |

(x)calculated from the difference total starch minus elutable starch
(xx)calculated from the quotient elutable starch divided by total starch in percent

### Example 5

### Degree of Breakdown of a Potato Product According to the Invention after Disintegration by Means of a Grating Process

25 kg of potatoes of the sort Allure were washed, mechanically peeled and subsequently comminuted in an ultra-grader into particles of up to 6 mm.

In the potato mash thus obtained the total starch as well as the elutable (“free”) starch was determined by polarimetric means after washing of the grated plant parts over a screen with a mesh opening of 100 μm (9). The share of bound starch was calculated as the difference of the total starch minus the elutable starch. For the grated potato mixture thus obtained the following results were determined:

| | |
|---|---|
| total starch | 77.5% |
| elutable starch | 68.1% |
| bound starch(x) | 9.4% |
| degree of breakdown(xx) | 87.9% |

(x)calculated from the difference total starch minus elutable starch
(xx)calculated from the quotient elutable starch divided by total starch in percent

### Example 6

### Production of a Potato Product with Depletion of Protein and Fruit Water Components

10,000 kg of potatoes of the sort Festin were cleaned, peeled and graded by means of a grader into a grated plant parts with a particle size of between 0.05 to 3 mm. The water content of the grated plant parts was examined and if necessary readjusted.

After adding approximately 100 mg/l of an antioxidant, the grated plant parts with a solids content of approximately 22% was guided over a solid bowl centrifuge, where the fruit water was separated and supplied to further protein extraction—without separating the present starch granules from the suspended grated plant parts.

Subsequently, the grated plant parts that was depleted of protein was diluted with drinking water to a solids content of between 10 to 20% and dehydrated once more by means of a decanter to approximately 30 to 45% dry matter.

Subsequently, the grated plant parts that was depleted of protein and soluble fruit water components was transferred onto a roller dryer where it was dried until it had a residual moisture of approximately 5.5%.

The grated plant parts film was removed from the drying drum, transferred into a screening machine and sieved over 3 mm.

Analysis of the flake-shaped plant product thus obtained showed the following results as compared to a non-depleted grated plant mixture (values respectively referring to the dry matter).

| | | product according to the |
|---|---|---|
| | grated plant mixture | invention F-10126 |
| protein(1) | 9.1% | 2.6% |
| glycoalkaloids(4) | 387 ppm | 51 ppm |
| sugars(2) | 1.5% | 0.2% |
| asparagine(3) | 0.9% | 0.2% |

### Example 7

Comparison of the Typical Concentrations of Grain Contents of Dried Field Peas and Those of the Food Product which has been Depleted According to the Invention Based on Shelled Peas (Values Respectively Referring to the Dry Matter).

| | | pea flakes (xx) product according to | |
|---|---|---|---|
| | field pea | the invention F-10206 | dried (xxx) |
| protein | 25.3% | 23.7% | 2.9% (1) |
| sugar | 3.9% | 4.7% | 0.1% (2) |
| fat | 1.0% | 1.8% | 0.2% (5) |

(xxx): field peas (pisum arvense), source: Merkblatt Erbse, Bio Austria, A-1040 Vienna.
(xx): pea flakes “Dobrodiya” by Luhanskmyln LLC, Ukraine.

The pea product according to the invention contains considerably less protein, sugars and fat than commercially available dried peas, or than the corresponding pea flour that may be produced by grinding the dried peas. Because of this fact, rancidification and bacterial decomposition can at least be delayed thanks to the lower content of fats and sugars.

The following application examples clarify the positive impact of the plant products according to the invention on the optimization of food for human consumption by using the example of lowering the content of unhealthy acrylamide in extruded and fried snack products.

### Example 8

### Production of Baked Potato Snacks (Stacked Chips) with Reduced Browning and Lowered Acrylamide Content after Replacement of 50% of Conventional Potato Flakes with the Potato Product According to the Invention F-10126

Two doughs with the following composition have been produced as described in the following, respectively:

Recipes
(information in wt. %
dry basis)

| | Recipe 8.1 | Recipe 8.2 |
|---|---|---|
| potato flake | 50 | 25 |
| F-10126 | 0 | 25 |
| relative flake replacement in % | 0 | 50 |
| [modified] starch | 25 | 25 |
| wheat flour | 20 | 20 |
| emulsifying auxiliary agents | 1.5 | 1.5 |
| sugar (saccarose) | 1.5 | 1.5 |
| table salt | 2.0 | 2.0 |

The potato flake (=EMFLAKE® 3911) or F-10126, modified starch, flour and the emulsifier are put together in dry form and mixed inside a universal food processor device for 30 seconds. Then, salt and sugar are dissolved at approximately 8% in water with a temperature of 20° C., and the solution is added to the dry mix described above. The resulting dough is kneaded for 5 minutes by means of dough hooks at level 1 of the kitchen appliance. Afterwards, the dough is kneaded by hand for approximately 5 minutes and rolled through a roller gap of 0.5 mm by using the dough-rolling machine by Rondo. The rolled-out dough is perforated by using an indented spatula and cutting out “chip blanks” from the dough with a round cutout form (diameter approximately 30 mm), and then the chip blanks are dried for 30 minutes at 95° C. inside a convection oven and subsequently cooled down to approximately 20° C. Afterwards, the blanks are deep-fried in deep-frying fat for 60 seconds at 170° C. in a deep fryer. After having been taken out of the deep fryer, the potato snack products are placed on a commercially available kitchen paper to cool down to 20° C. and are carefully dabbed with the paper so as to remove any adhering fat.

The deep-fried chips prepared according to both recipes are subjected to a sensor-based assessment of the color/browning, taste and smell. The intensity of the browning can be regarded as an indicator for the formation of acrylamide as part of the Maillard reaction.

For color characterization by means of a standardized color space, the brightness value L* as well as the a* value (share of green (−) or red (+)) or the b* value (share of blue (−) or yellow (+)) of the potato snack products is determined (8).

For this purpose, the deep-fried staple chips are ground inside a laboratory impact mill by Ika to a grain size of <1000 μm and the powders are measured by means of a spectral photometer by Minolta.

Results

| | Recipe 8.1 | Recipe 8.2 |
|---|---|---|
| share of potato flake in recipe | 50% | 25% |
| share of F-10126 in recipe | 0% | 25% |

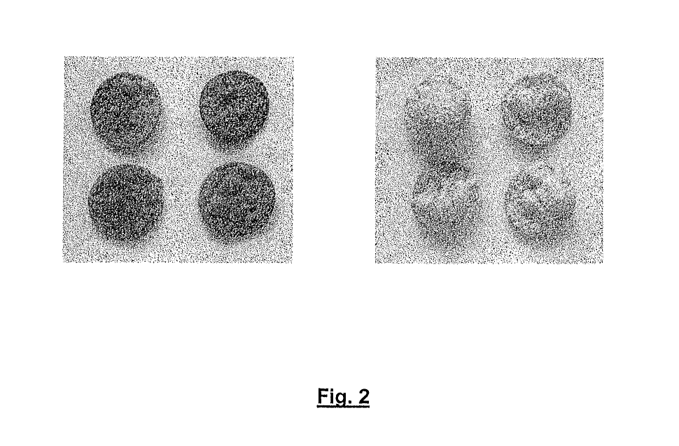

Photos of the baked stacked chips are shown in FIG. 2.

| | | |
|---|---|---|
| color perception (visually | brown, dark | beige, light |
| assessed) | | |
| L* value | 68.9 | 75.5 |
| a* value | +27.7 | +21.4 |
| b* value | +8.4 | +3.1 |
| acrylamide content(7) | 1590 (μg/kg) | 803 (μg/kg) |

While both final products show good dough processability characteristics and comparable sensorial properties, such as typical potato taste, pleasant potato-like smell and crispy texture, the potato snack prepared by using F-10126 shows almost no browning reaction due to its considerably reduced sugar and asparagine content.

Photos of the chips that were made with the commercially available potato flakes (EMFLAKE® 3911) as well as the potato flakes according to the invention (F-10126) are shown in FIG. 2. It is clearly visible that the potato flakes according to the invention show less browning and thus contain less acrylamide.

Measurements of the acrylamide concentration confirm that the content of unhealthy acrylamide is reduced by 50% as compared to the reference recipe 4.1. Thus, by using the described cleaned plant products with a lesser content of harmful substances, healthier foods can be produced.

### Example 9

### Production of Indirectly Extruded Potato Snack Product with High Expansion Capability During Deep-Frying, Reduced Browning and Lowered Acrylamide Content by Using the Potato Product According to the Invention F-10126

Two mixtures according to the recipes 9.1 and 9.2 with the following composition are produced as respectively described:

Recipes
(information in wt. %
dry basis)

| | Recipe 9.1 | Recipe 9.2 |
|---|---|---|
| potato flake | 50 | 0 |
| F-10126 | 0 | 50 |
| relative flake replacement in % | 0 | 100 |
| native potato starch | 48 | 48 |
| emulsifying auxiliary agents | 1 | 1 |
| table salt | 1 | 1 |

The potato flake (=EMFLAKE® 3847) or F-10126, native potato starch, salt and the emulsifier are put together in dry form and mixed for approximately 600 seconds inside a drum mixer.

Then, the resulting dry mixture is extruded in a twin-screw extruder and directly granulated after exiting from the extruder die. During the supply to the extruder, 20 wt. % of water is continuously added to the dry mix.

The semi-finished products are subsequently dried in a convention oven at 30° C. and 25% relative humidity until they reach a moisture content of under<12%, and then deep-fried inside a deep fryer in deep-frying fat for 40 seconds at 190° C. After having been taken out of the deep fryer, the potato snack products are placed on commercially available kitchen paper to cool down to 20° C. and carefully dabbed with the paper so as to remove any adhering fat.

The calculation of bulk densities is carried out by means of volume determination of 30 g pallets, respectively, which are put into a measuring cylinder and compacted by striking the cylinder three times.

Results

| | Recipe 9.1 | | Recipe 9.2 | |
|---|---|---|---|---|
| share of potato flake in recipe | 50% | | 0% | |
| share of F-10126 in recipe | 0% | | 50% | |
| volume semi-finished product | 68 | ml | 68 | ml |
| volume final production | 128 | ml | 170 | ml |
| increase in volume | 188% | | 250% | |
| bulk density before expansion | 443 | g/l | 442 | g/l |
| (semi-finished product) | | | | |
| bulk density after expansion (final product) | 243 | g/l | 188 | g/l |

| | | |
|---|---|---|
| decrease in bulk density | 182% | 235% |
| color of final product (visually assessed) | brown- | pale-yellow |
| | yellow | |
| acrylamide(7) | 1710 (μg/kg) | 337 (μg/kg) |

While showing good processing properties in the extrusion process, the snack pallet produced by using F-10126 has a considerably higher increase in volume after the deep-frying process as compared to the reference at the same bulk density/volume of the semi-finished product. Here, too, measurements of the acrylamide concentration after deep-frying confirm that the content of unhealthy acrylamide is reduced by 80% as compared to the reference recipe.

### Measurement Methods

Determinations were carried out according to the following methods:

(1): Nitrogen determination according to Kjeldahl (Nx6, 25), DIN EN ISO 3188
(2): Method according to Luff-Schoorl, NEN 3571
(3): UV test by mt-diagnostics GmbH, Idstein, for enzymatic determination of asparagine and aspartic acid

### (4): Method 997.13, Association of Analytical Communities (AOAC)

(5): Fat determination in a Soxhlet appliance by extraction in ether

### (6): Method 991.43, by Association of Analytical Communities (AOAC)

(7): HPLC-MSMS In-house method of LUFA-ITL GmbH
(8): Color values according to DIN EN ISO 11664-04
(9): Polarimetric method according to Ewers, DIN EN ISO 10520

Based on the process according to the invention and the products that can be produced with it, a high degree of separation is facilitated for reducing sugars as well as for asparagine so that it becomes possible to dispense with the use of special potato varieties with low sugar content. The addition of special additives in food production for lowering the acrylamide formation is also no longer necessary. Consequently, healthier food products with considerably reduced contents of carcinogenic substances can be produced by using the described innovative potato products.

1. Plant-based particulate food product produced from plant parts containing starch, characterized in having:
at least one content of a constituent that can be removed by means of water that is reduced by 20 to 90 wt. % of the original content in comparison with the native plant part, and preferably 30 to 70 wt. %, and particularly preferably 35 to 65 wt. % of the original content in comparison with the native plant part.

2. Food product according to claim 1, characterized in that the at least one depleted constituent that can be removed by means of water is starch.

3. Food product according to claim 1 or 2, characterized in that the at least one depleted constituent that can be removed by means of water is protein and amino acids.

4. Food product according to one of the preceding claims, characterized in that the at least one depleted constituent that can be removed by means of water is the sugars.

5. Food product according to one of the preceding claims, characterized in that the at least one depleted constituent that can be removed by means of water is elutable fibers.

6. Food product according to one of the preceding claims, characterized in that the at least one depleted constituent that can be removed by means of water is alkaloids, glycoalkaloids.

7. Food product according to one of the preceding claims, characterized in that the plant parts containing starch are selected from root crops and tubers; legumes and their fruits, fruits of trees; herbaceous plants and fruits of herbaceous plants; sweet grasses and their fruits, as well as algae.

8. Food product according to one of the preceding claims, characterized in that it has a content of at least one processing auxiliary agent, selected from the group comprising: binders, emulsifiers, antioxidants, flavors, enzymes, and dyes.

9. Food product according to one of the preceding claims, characterized in that it is present in the form of dried flakes, powder, granulate, with an average diameter (statistical mean) of 0.02 mm to 10 mm, preferably 0.05 to 5 mm, and particularly preferably 0.2 to 4 mm.

10. Food product according to one of the preceding claims, characterized in that it is a food or food supplement product, dietary food or food supplement meant for human or animal consumption.

11. Process for producing a food product according to one of the preceding claims, comprising the steps of:
providing plant parts containing starch,
grinding the plant parts into particles with an average particle size (statistical mean) of 0.02 mm to 10 mm, preferably 0.05 to 5 mm, and particularly preferably 0.2 to 4 mm, addition of water with a pH value between 5.0 and 12.0, preferably a pH value between 6.5 to 8.5 resulting in an aqueous suspension with between 10 and 50 wt. %, preferably 15 to 40 wt. % and particularly preferred 16 to 35 wt. % dry substance;
separating of the fluid resulting in food-components;
at least one washing of the obtained food components in water until a depletion of components removable with water is achieved that amounts to 20 to 90 wt. % less of components removable by means of water; and
drying of the thus produced depleted food product particles.

12. Process according to claim 11, characterized in that before drying the comminuted plant parts are subjected to a temperature treatment step in the temperature range of between 15 to 100° C., preferably 20 to 80° C., and particularly preferably 30 to 70° C.

13. Process according to claim 11 or 12, characterized in that the plant product is treated by one or multiple of the following steps: blanching or cooking.

14. Process according to claim 11 to 13, characterized in that the desired starch/sugar/protein content of the dried grated plant mixture is adjusted by way of analyses of the process products.
